(19) United States
(12) Patent Application Publication
(10) Pub. No.: US 2013/0260972 A1
(43) Pub. Date: Oct. 3, 2013

(54) Drill bit container to feed a drill

(71) Applicant: Jim Polasek, Spring Branch, TX (US)

(72) Inventor: Jim Polasek, Spring Branch, TX (US)

(21) Appl. No.: 13/433,112

(22) Filed: Mar. 28, 2012

(51) Int. Cl. B23B 45/00

(52) U.S. Cl. CPC B23B 45/003
USPC 483/58

(57) ABSTRACT

A drill bit container to feed a drill with drill bits may include the bit container being formed to access a drill body of the drill, and a continuous belt to mount a plurality of drill bits. The continuous belt may rotate to individually feed a preselected drill bit to the drill. The bit container may be translucent. The bit container may be transparent. The bit container may include a locking button. The drill may include a sliding lever to feed the drillbit to a chuck of the drill. The drillbit may be transversely mounted on the continuous belt.

### FIELD OF THE INVENTION

The present invention relates to drills and drill bits and more particularly to a drill bit container which may automatically feed drill bits to a drill.

### BACKGROUND

For a number of years, drill bits have been commonly used, for example in industry, for cutting holes in sheet metal or wood. However, in order to drill a different sized hole, a new drill bit must replace the original drill bit. This usually involves different drill bits to be mounted to and dismounted from a chuck of a powered tool.

### SUMMARY

A drill bit container to feed a drill with drill bits may include the bit container being formed to access a drill body of the drill, and a continuous belt to mount a plurality of drill bits.

The continuous belt may rotate to individually feed a preselected drill bit to the drill.

The bit container may be translucent.

The bit container may be transparent.

The bit container may include a locking button.

The drill may include a sliding lever to feed the drillbit to a chuck of the drill.

The driver/drill bit may be transversely mounted on the continuous belt.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a bit container to be used to hold driver/drill bits which may be of different sizes in order to be inserted into a drill;

FIG. 2 illustrates the bit container and the drill;

FIG. 3 illustrates a cross-sectional view of the endless belt and driver/drill bits to be used with the bit container of the present invention;

FIG. 4 illustrates a top view of the endless belt and a driver/drill bit to be used with the bit container of the present invention;

FIG. 5 illustrates the bit container and drill in a first position;

FIG. 6 illustrates the bit container dispensing a driver/drill bit into the drill in a second position;

FIG. 7 illustrates the drill placing the driver/drill bit into an operating position in the drill in a third position;

FIG. 8 illustrates the drill returning to the original position with the driver/drill bit in now operating position in a fourth position.

### DETAILED DESCRIPTION

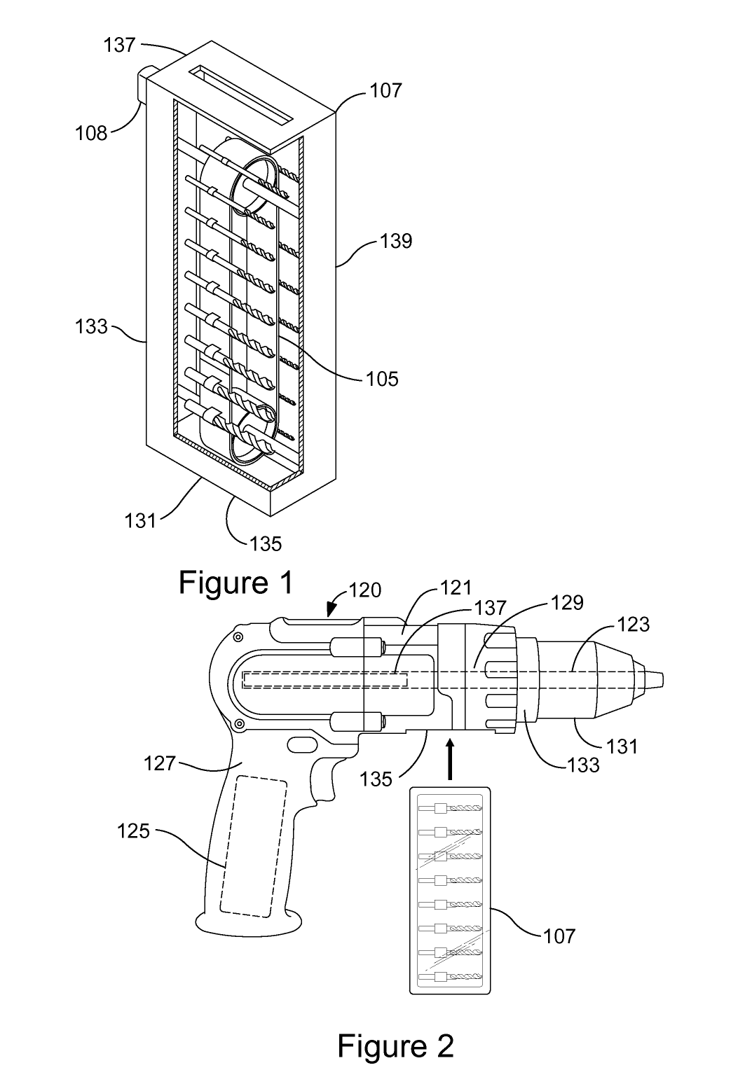

FIG. 1 illustrates a perspective view of the bit container 107 which may be a rectangular container, and oval container or other shape in which may include a front wall 131 which may be connected to a pair of opposing side walls 133, a bottom wall 135 and a top wall 137 and may include a pair of opposing side walls 133 which may be connected to the front wall 131, a back wall 139, a top wall 137 and a bottom wall 135 and may include a bottom wall 135 which may be connected to a pair of opposing side walls 133, the front wall 131 and the back wall 139 and may include a top wall 137 which may be connected to the front wall 131, the back wall 139 and the pair of opposing side walls 133 and may include a back wall 139 which may be connected to the pair of opposing side walls 133 the top wall 137 and the back wall 139. The front wall 131, the sidewall 133, the back wall 139, the bottom wall 135 and the top wall 137 may define a cavity.

The bit container 107 may be formed from rigid plastic, metal, glass or other appropriate material and may be formed from transparent or translucent material in order that the driver/drill bit 101 may be seen before it is the dispensed into the drill body 129. Different size drill bits 101 may be contained in the bit container 107 so the driver/drill bits 101 may be selected without the need to remove the driver/drill bit 101 from the bit container 107.

The bit container 107 may include a locking button 108 to hold the bit container 107 into the drill body 129 and to limit the movement of the drillbit'101 to a predetermined number of clicks so that the driver/drill bit 101 may line up correctly in the drill body 129.

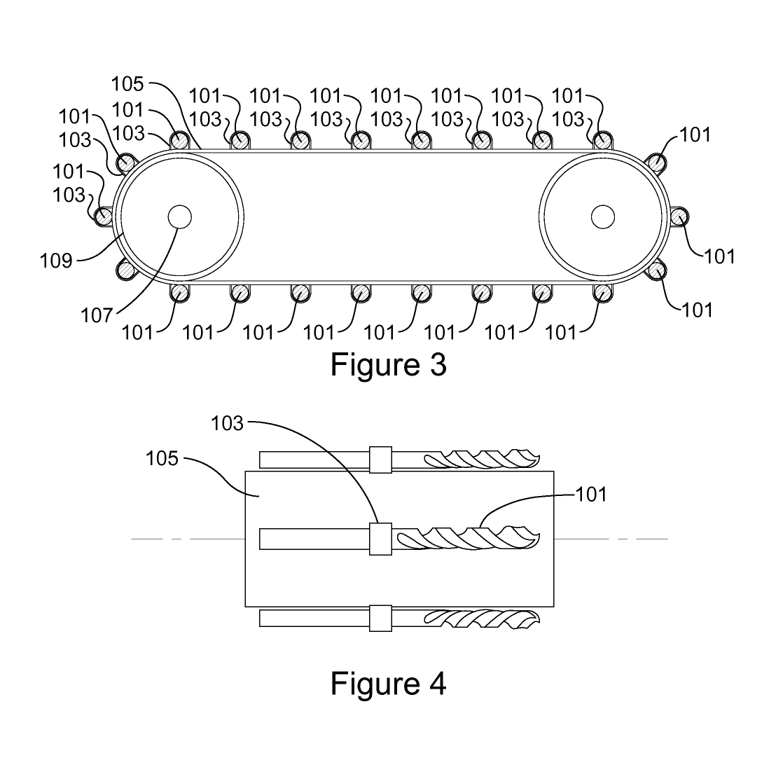

FIG. 3 illustrates a continuous belt 105 which may include a multitude of drill bits 101 which may be transversely mounted on the continuous belt 105. The continuous belt may include a multitude of flexible and expandable straps 103 which may be expandable in order to retain different size driver/drill bit 101. The continuous belt 105 may be positioned and driven by a opposed pair of belt drive wheels 109 which may be connected to a shaft 107.

FIG. 4 illustrates a portion of the continuous belt 105 having a driver/drill bit 101 being mounted traverse to the direction of movement of the continuous belt 105 and a flexible and expandable straps 103 to hold the driver/drill bit 101 on the continuous belt 105.

FIG. 2 illustrates a powered tool 120 which may be for example an electric drill and which may include a drill motor 133 which may be connected to a drill battery 125 to supply power to the drill motor 133. The drill motor 133 may drive a chuck 131 which may be adjusted to accept varying sized driver/drill bit 101. The drill battery 125, the drill motor 133 and the chuck 131 may be enclosed within a drill housing 129 which may include a handle 127.

The drill housing 129 may include an aperture 135 to accept the bit container 107 and may include a channel 123 which may extend through the drill housing 129 and through the chuck 131. The channel 123 may cooperate with the bit container 107 by allowing the bit container 107 to urge a single selected driver/drill bit 101 into the channel 123, and the channel 123 may cooperate with a sliding lever 137 which may slide along the channel 123 in order to urge the driver/drill bit 101 towards the and through the chuck 131. The sliding lever 137 may include an arm 131 which may extend in the traverse direction from the sliding lever 137.

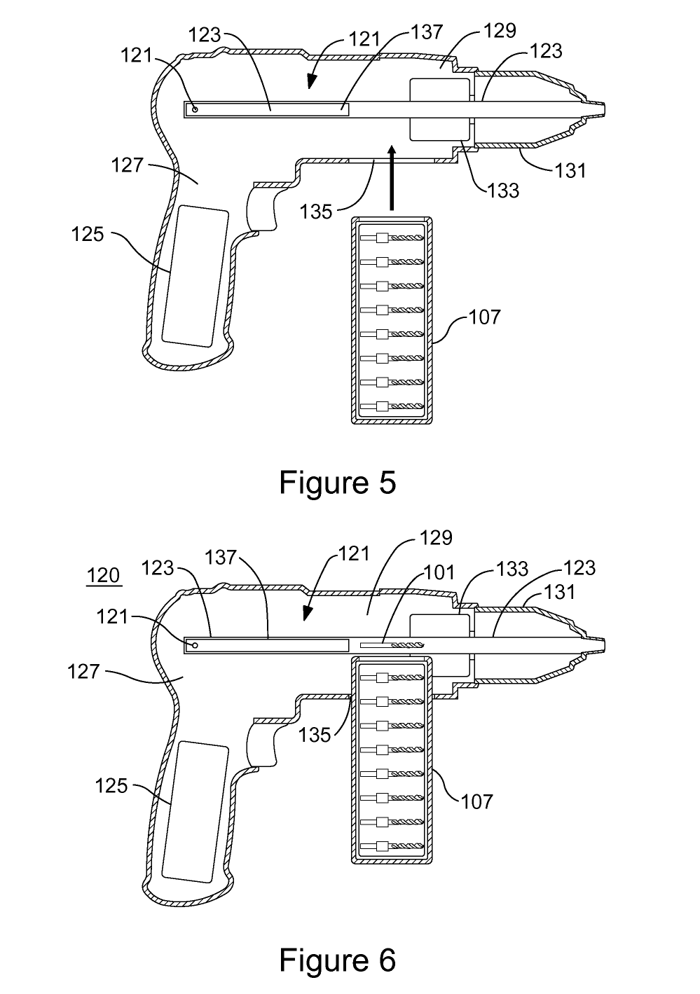

FIG. 5 illustrates a powered tool 120 which may be for example an electric drill and which may include a drill motor 133 which may be connected to a drill battery 125 to supply power to the drill motor 133. The drill motor 133 may drive a chuck 131 which may be adjusted to accept varying sized driver/drill bit 101. The drill battery 125, the drill motor 133 and the chuck 131 may be enclosed within a drill housing 129 which may include a handle 127.

The drill housing 129 may include an aperture 135 to accept the bit container 107 and may include a channel 123 which may extend through the drill housing 129 and through the chuck 131. The channel 123 may cooperate with the bit container 107 by allowing the bit container 107 to urge a single selected driver/drill bit 101 into the channel 123, and the channel 123 may cooperate with a sliding lever 137 which may slide along the channel 123 in order to urge the driver/drill bit 101 towards the and through the chuck 131. The sliding lever 137 may include an arm 131 which may extend in the traverse direction from the sliding lever 137.

FIG. 5 illustrates that the bit container 107 has entered the aperture 135 and the sliding lever 137 has been withdrawn to its rearmost position.

FIG. 6 illustrates a powered tool 120 which may be for example an electric drill and which may include a drill motor 133 which may be connected to a drill battery 125 to supply power to the drill motor 133. The drill motor 133 may drive a chuck 131 which may be adjusted to accept varying sized driver/drill bit 101. The drill battery 125, the drill motor 133 and the chuck 131 may be enclosed within a drill housing 129 which may include a handle 127.

The drill housing 129 may include an aperture 135 to accept the bit container 107 and may include a channel 123 which may extend through the drill housing 129 and through the chuck 131. The channel 123 may cooperate with the bit container 107 by allowing the bit container 107 to urge a single selected driver/drill bit 101 into the channel 123, and the channel 123 may cooperate with a sliding lever 137 which may slide along the channel 123 in order to urge the driver/drill bit 101 towards the and through the chuck 131. The sliding lever 137 may include an arm 131 which may extend in the traverse direction from the sliding lever 137.

FIG. 6 illustrates that a driver/drill bit 101 as entered the channel 123 and the sliding lever 135 remains in the rearmost position.

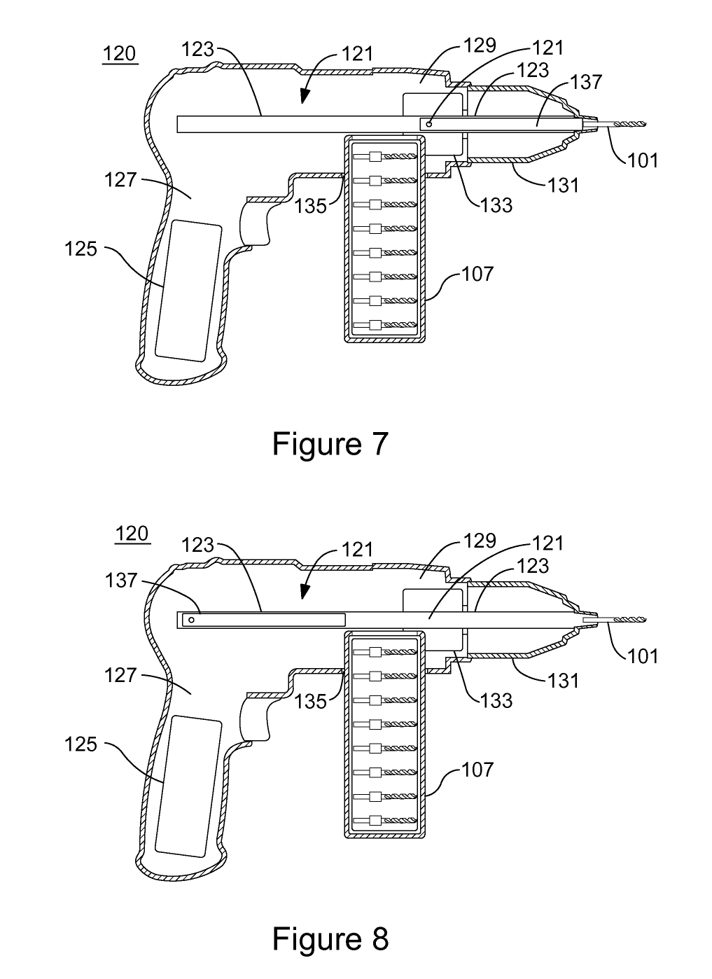

FIG. 7 illustrates a powered tool 120 which may be for example an electric drill and which may include a drill motor 133 which may be connected to a drill battery 125 to supply power to the drill motor 133. The drill motor 133 may drive a chuck 131 which may be adjusted to accept varying sized driver/drill bit 101. The drill battery 125, the drill motor 133 and the chuck 131 may be enclosed within a drill housing 129 which may include a handle 127.

The drill housing 129 may include an aperture 135 to accept the bit container 107 and may include a channel 123 which may extend through the drill housing 129 and through the chuck 131. The channel 123 may cooperate with the bit container 107 by allowing the bit container 107 to urge a single selected driver/drill bit 101 into the channel 123, and the channel 123 may cooperate with a sliding lever 137 which may slide along the channel 123 in order to urge the driver/drill bit 101 towards the and through the chuck 131. The sliding lever 137 may include an arm 131 which may extend in the traverse direction from the sliding lever 137.

FIG. 7 illustrates that the sliding lever 137 has advanced and engage the driver/drill bit 101 and advanced the drill. 101 into the chuck 131 when the chuck may be tightened to secure the driver/drill bit 101.

FIG. 8 illustrates a powered tool 120 which may be for example an electric drill and which may include a drill motor 133 which may be connected to a drill battery 125 to supply power to the drill motor 133. The drill motor 133 may drive a chuck 131 which may be adjusted to accept varying sized driver/drill bit 101. The drill battery 125, the drill motor 133 and the chuck 131 may be enclosed within a drill housing 129 which may include a handle 127.

The drill housing 129 may include an aperture 135 to accept the bit container 107 and may include a channel 123 which may extend through the drill housing 129 and through the chuck 131. The channel 123 may cooperate with the bit container 107 by allowing the bit container 107 to urge a single selected driver/drill bit 101 into the channel 123, and the channel 123 may cooperate with a sliding lever 137 which may slide along the channel 123 in order to urge the driver/drill bit 101 towards the and through the chuck 131. The sliding lever 137 may include an arm 131 which may extend in the traverse direction from the sliding lever 137.

FIG. 8 illustrates that the driver/drill bit 101 has been secured by the chuck 131 and the sliding lever 137 has been returned to the rearmost position.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A drill bit container to feed a drill with drill bits, comprising:
the bit container being formed to access a drill body of the drill;
a continuous belt to mount a plurality of drill bits
wherein the continuous belt rotates to individually feed a preselected drill bit to the drill.

2) A drill bit container to feed a drill with drill bits as in claim 1, wherein the bit container is translucent.

3) A drill bit container to feed a drill with drill bits as in claim 1, wherein the bit container is transparent.

4) A drill bit container to feed a drill with drill bits as in claim 1, wherein the bit container includes a locking button.

5) A drill bit container to feed a drill with drill bits as in claim 1, wherein the drill includes a sliding lever to feed the drill bit to a chuck of the drill.

6) A drill bit container to feed a drill with drill bits as in claim 1, wherein the drill bit is transversely mounted on the continuous belt.
